(19) United States
(12) Patent Application Publication
(10) Pub. No.: US 2021/0038456 A1
(43) Pub. Date: Feb. 11, 2021

(54) SYSTEM FOR PROVIDING FLUID TO A DISTRIBUTED NETWORK OF CHAMBERS

(71) Applicant: Simbex LLC, Lebanon, NH (US)

(72) Inventors: Michael A. Kokko, Lyme, NH (US); Spencer C. Brugger, Orford, NH (US); Jeffrey J. Chu, Norwich, VT (US); Richard M. Greenwald, Lebanon, NH (US)

(73) Assignee: Simbex LLC, Lebanon, NH (US)

(21) Appl. No.: 16/987,793

(22) Filed: Aug. 7, 2020

Related U.S. Application Data
(60) Provisional application No. 62/884,491, filed on Aug. 8, 2019.

(51) Int. Cl. A61G 7/057

(52) U.S. Cl. CPC A61G 7/05776; A61G 2203/30; A61G 2203/10; A61G 7/05723

(57) ABSTRACT

The fluid manifold system includes one or more primary chambers and one or more secondary chambers. Each of the one or more secondary chambers contains a volume of fluid and is connected to an underlying primary chamber, which also contains a volume of fluid. Valves are provided, either distributed throughout the manifold to minimize flow restriction or collected into one or more discrete valve manifolds, which are removably connected to the primary and secondary chambers with flexible tubing or the like. Activating a single valve disconnects one or more of the secondary chambers from the associated primary chamber and connects the same one or more secondary chambers to an alternate primary chamber.

### CROSS-REFERENCE TO RELATED APPLICATION

This application claims priority to earlier flied U.S. Provisional Patent Application No. 62/884,491, filed on Aug. 8, 2019, the entire contents of which are incorporated herein by reference.

### GOVERNMENT LICENSE RIGHTS

This invention was made with government support under award R44NR014388 awarded by the National Institutes of Health. The government has certain rights in the invention.

### BACKGROUND OF THE INVENTION

The present invention relates to a system for providing fluid to a distributed network of chambers. The present invention relates to the field of medical equipment, particularly to support surfaces for prevention and treatment of pressure ulcers. The present invention relates to the control of support surfaces to minimize tissue interface pressure. More specifically, the present invention relates to a system for providing fluid to a distributed network of chambers that comprise a support surface for prevention and treatment of pressure ulcers.

It is well known in the medical field that pressure ulcers are a major problem in hospital and nursing care. In the US alone, pressure ulcers afflict approximately 2.5 million people annually and cause 60,000 deaths. In bedridden or wheelchair confined patients, pressure ulcers are caused by the force of the bed surface or wheelchair pad on the patient. Nurses will utilize a turning scheduled to help alleviate the pressure on specific areas of the body. The fundamental cause of pressure ulcers has been the subject of research studies for decades. It is generally accepted that external mechanical loading is the primary cause, but the actual mechanisms leading to pressure ulcer formation are still unclear. A widely held hypothesis is that tissue compression prevents the blood stream from supplying nutrients and oxygen to a localized area (capillary perfusion) eventually blocking the flow entirely (ischemia). After the load is removed and blood flow returns inflammation and cell damage may become evident as the tissue can no longer function normally (reperfusion injury). The tissue closest to the bone is most susceptible to necrosis, the death of living cells or tissue caused by conditions such as ischemia. Pressure ulcers tend to form at these sites. Thus, pressure relief is the cornerstone of pressure ulcer prevention. In addition to direct pressure or tissue interface pressure (TIP), other ulceration mechanisms are thought to include shear and friction loading. Since both of these variables depend on interface pressure, reducing interface pressure will reduce both shear and friction.

Support surfaces can be characterized as reactive or active. Reactive systems, which change load distribution only with a change in applied load, are typically based upon immersion and envelopment of the individual with respect to the surface. Immersion into the surface and envelopment of the surface material around the body increases the contact area of the body with the surface, which reduces contact pressure. Once immersed and enveloped, however, the pressure applied to the skin and underlying tissues remains constant until the patient moves, the surface is moved, such as might occur if the bed is articulated, or an external load is applied to the surface, such as might occur if an object is placed on the surface or a person sits on the surface. The pressure applied to the skin and underlying tissues may exceed the level at which pressure ulcer formation will occur. Active systems, which can change load distribution independent of applied load, involve periodic redistribution of pressure to the skin and underlying tissues, often via the inflation or deflation of fluid-filled cells or chambers, often air filled, or other relevant technology.

Current reactive and active support surfaces do not necessarily solve the problem that the patient can encounter transient pressure gradients and points of elevated pressure that can contribute to pressure ulcer formation. This may be a result of the load-bearing medium of the mattress not reacting in a linear manner to patient weight, or to the patient moving while on the support surface, or that the geometry and shape of the human body is complex and high individualized. The reactive forces generated are not independent of the amount and location of loads across the mattress surface, causing variation in the support and envelopment characteristics of the medium. With passive reactive systems, an incident load can partially collapse the support material in the area surrounding a contact point, degrading load-bearing properties. Typical air mattresses use tubular chambers running across the width of the bed to decouple loadbearing partitions, but distortion can still take place along the tube cross section and length.

Pressure redistribution is one of several factors known to prevent pressure ulcers and aid in treatment. Pressure redistribution support surfaces include foam, air inflatable, alternating pressure, low air loss, and air fluidized (AFT of ‘sand bed”) therapies.

Clinicians report dissatisfaction with the cost, usability, and patient experience of existing support surface products for treatment of decubitus ulcers and providing post-flap/graft surgery care. There is a need for a support surface designed to intelligently and selectively offload high-risk tissue. Such a system can improve patient care and reduce caregiver workload and fatigue. The key property of a therapeutic support surface for treatment of pressure ulcers is its ability to maximize and preserve contact with the body to distribute the patient's weight evenly over a broad surface and to eliminate excessive tissue interface pressure on bony protuberances where ulcers generally occur. In addition, effective management of the temperature and moisture of the tissue-surface environment is considered essential for preventing or healing pressure ulcers, and improving patient comfort.

Most prior art methods for immersion of the body or body part of a patient require or incorporate sensors, measurements, or external inputs as part of the immersion schema. For example, the individuals' weight and or height may be required to be entered or measured. An alternative approach is to sense pressure and pressure changes in a fluid-filled chamber on which an individual is sitting or lying, and to immerse the patient to a set pressure. Another alternative approach is to use displacement monitor to quantify a distance between the patient and the bottom of the support surface. Camera and video systems could also be used and temperature as a proxy for interface pressure. In some cases, a pressure mat is utilized to drive the immersion process. These pressure mats may actually change the characteristics of the support surface itself compared to when a pressure mat is not present.

Fluid-powered systems are widely used in science, medicine, manufacturing, and similar fields. One of the most common fluid system topologies collects valves for controlling flow between reservoirs and actuators into discrete manifolds with flexible or rigid tubing running between connecting these manifolds with other system components. This strategy can be efficient in applications where tubing can be accommodated physically and where it presents an acceptable restriction to flow; however, flow restriction and tubing management often limit overall system size and/or functionality. Moreover, the number of tubes and valves preferably scale with the number of individually controlled elements. More tubes and valves not only increases physical dimensions, but also increases cost and adds additional failure points.

Many state-of-the-art air powered support surfaces used in the prevention and treatment of decubitus ulcers (pressure ulcers) are structured in this way, with centralized valves housed in a control unit and a series of tubes running from the valves to individual air chambers inside a therapeutic mattress. A small number of air chambers can be controlled in this manner; however, increasing the number of chambers to provide more targeted care requires additional tubing which quickly becomes difficult to manage. In cases where overall tubing bundle thickness is limited, increasing the number of chambers necessarily reduces the maximum acceptable tubing diameter which restricts airflow. It should be further noted that this impacts the ability to independently control chambers and the performance of the chambers, namely, how quickly they can inflate/deflate and the controllability of internal chamber pressure.

### SUMMARY OF THE INVENTION

The fluid manifold system includes one or more primary chambers and one or more secondary chambers. Each of the one or more secondary chambers contains a volume of fluid and is connected to an underlying primary chamber, which also contains a volume of fluid. Valves are provided, either distributed throughout the manifold to minimize flow restriction or collected into one or more discrete valve manifolds which are removably connected to the primary and secondary chambers with flexible tubing or the like. Activating a single valve disconnects one or more of the secondary chambers from the associated primary chamber and connects the same one or more secondary chambers to an alternate primary chamber. Valves are preferably removably connected to at least one chamber, such as the primary and/or secondary chambers.

An object of the present invention is to provide an improved support surface for patients to minimize tissue interface pressure for the prevention and treatment of ulcers, and the like.

A further object of the method of the present invention is to provide an improved system for providing fluid to a distributed network of chambers.

### BRIEF DESCRIPTION OF THE DRAWINGS FIGURES

FIGS. 1A-C show respective plan views of the top sheet, middle sheet and bottom sheet of the system of the present invention;

FIGS. 2A-C show respective perspective views of the top sheet, middle sheet and bottom sheet of the system of the present invention;

FIG. 3 shows a cross-sectional view of the manifold system of the present invention;

FIG. 4 shows an alternative embodiment of the present invention with a plurality of primary chambers:

FIGS. 5A and 5B show channel groupings in accordance with the present invention; and

FIG. 6 show a flow chart of the control system of the present invention.

### DESCRIPTION OF THE INVENTION

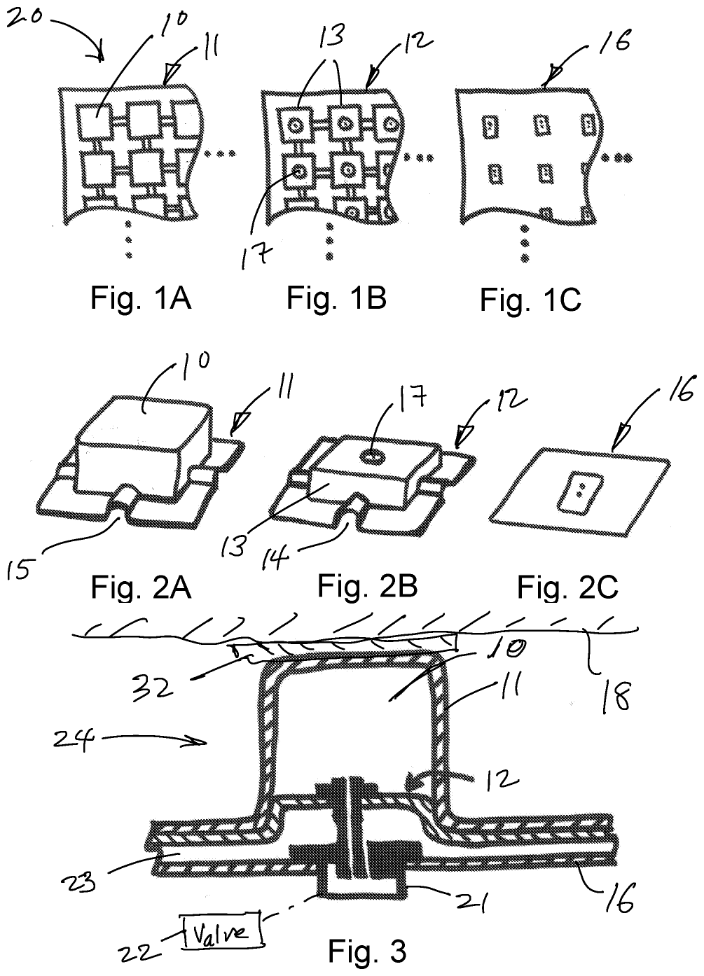

The present invention addresses these limitations with a distributed network of valves, essentially running electrical wires rather than tubing throughout the system. As shown in FIGS. 1A-C, a plan view of the preferred embodiment is achieved by a multi-layer, flexible mat 20 in which an array of patient support chambers 10 are provided. FIGS. 2A-C show perspective views of the respective top 11, middle 12 and bottom sheets 16.

In FIGS. 1A and 2A, the top sheet 11, is shown, which is preferably made of polyurethane. This top sheet 11 is bonded to a middle sheet 12, which is shown in FIGS. 1B and 2B. The middle sheet 12 is preferably made of polyurethane, containing shorter thermoformed chambers 13, all of which are interconnected via intercommunication channels 14 with each other. Finally, a third unformed sheet 16, as seen in FIGS. 1C and 2C, is preferably made of polyurethane, is bonded to the bottom of the middle sheet 12.

FIG. 3 shows a cross-sectional view of the assembled top sheet 11, middle sheet 12 and bottom sheet 16 focusing on a single chamber for illustrative purposes and for ease of discussion. It should be understood that an array of such chambers are provided in accordance with the present invention. A valve adapter component 21 or series of valve adapter components 21 allow for the mechanical and fluidic connection of valve 22 or valves 22 which, in their unactuated states, allow air to flow between the interconnected lower layer 23, called a primary chamber and individual patient support chambers 10, also called a secondary chamber 4 or secondary chambers via an orifice 17 in the middle sheet. This forms a flexible manifold, generally referenced as 24. For ease of illustration, valve 22 is conceptually shown as interconnected to the valve adapter component 21.

Since the middle sheet 12 is thermoformed with intercommunication channels, it can be determined how adjacent cells communicate (i.e. share air with each other). For example, there may be four-way intercommunication channels, but depending on application, there may be less than four cells or greater than four, such as cells diagonally connected. For example, with bolsters that line the sides of the bed, which act as soft walls on the side of the bed to prevent patients from falling out of bed, it may only require intercommunication channels that run lengthwise of the bed since these bolsters tend to be higher pressure than the actual patient support surface.

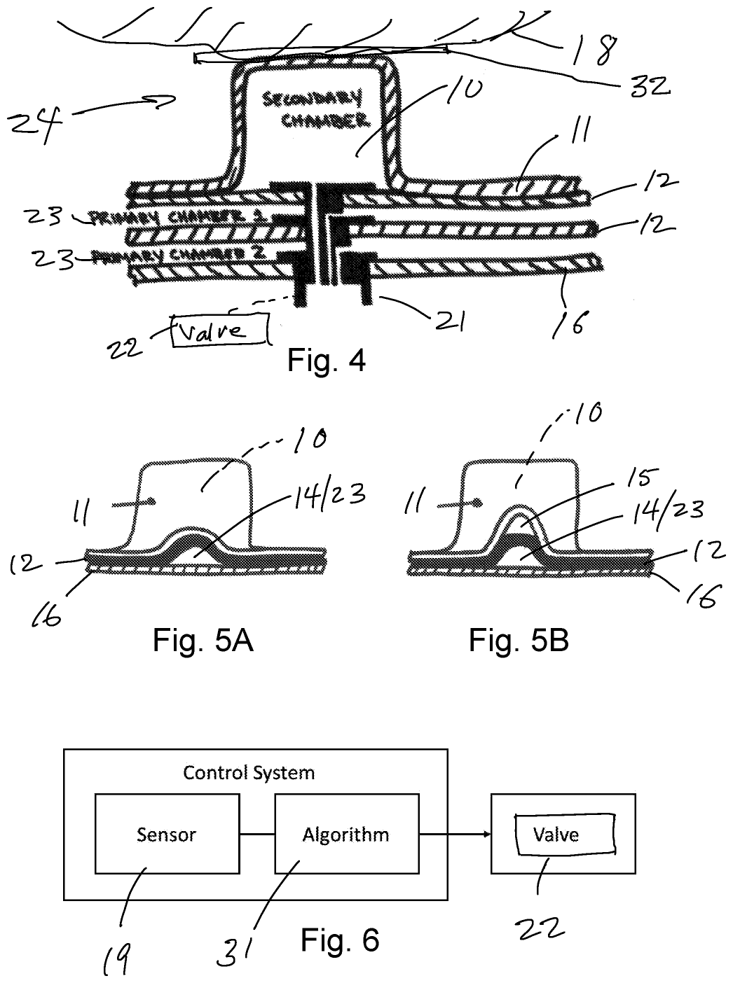

In this embodiment, actuating a valve 22 causes fluid such as pressurized air inside the associated patient support chamber 10 to exhaust and thereby reduces contact pressure in a region of the patient's skin 18. The exhaust can be to another flexible manifold 24 or to atmosphere. When multiple manifolds 24 are interconnected and used in conjunction with a control system 30, as seen in FIG. 6, for managing the valves 22 of the manifolds 24, the resulting mat 20 is capable of selectively reducing patient tissue interface pressure with high spatial resolution. As in FIG. 6, the control system 30 includes one or more sensors 19 which monitor parameters of interest related to tissue interface pressure for one or more manifolds 24. The data from the sensors 19 are fed into an algorithm 31 which is used to control the valve 22 for each manifold 24 or groups of manifolds 24. The sensor 19 can be integral to the manifold 24 or external to the manifold 24, and can measure patient displacement, skin interface pressure, chamber pressure, among others. An exemplar would be a pressure sensor 32, as seen in FIGS. 3 and 4, that is placed between the patient support chamber 10 and a patient's skin 18.

FIG. 4 shows a configuration of the present invention where two primary chambers 23 are used to form a manifold 24. In this configuration, two middle sheets 12 are positioned between the top sheet 11 and the bottom sheet 16. The valve adapter component 21 and valve 22 allows selection of which primary chamber 23 is operably connected to the secondary chamber 10 at any given time.

FIGS. 5A and 5B shows how multiple primary chambers 23 are utilized to form grouping channel 15 that allow multiple secondary chambers to be controlled by a single valve 22. More specifically, FIG. 5A shows normal, non-grouped cell channels while FIG. 5B shows a channel structure for cell grouping.

In accordance with the present invention, the additional primary chambers 10 provides an additional common manifold that could be used to provide an additional structure to connect patient support chambers 10 to group them in a way that manages pressure redistribution in body regions (e.g., high pressure regions including heels, head, and pelvis). The chambers allow pressure to flow to/from these chamber groupings.

Alternatively, it is further possible that a structure to exhaust fluid to a common chamber 10 so fluid can be reused in another region that requires air or has a lower pressure. This reduces the need to run pumps to save power and reduce sound. Further, if the fluid is liquid, it is possible to exhaust the fluid to common chamber for fluid management.

Still further, it is envisioned to provide different pressure set points where a higher pressure could be used to inflate a patient support chambers that comprise, for example, a patient support surface, quickly (e.g. starting from complete deflation) and another to provide slower more gradual inflation for better control and improved user experience

For rapid deflation of patient support chambers. For example, if CPR needs to be performed, the air in the patient support surfaces can be quickly deflated so the patient is on a rigid surface.

In other embodiments, the manifold system 20 may be fabricated from rigid materials, semi-rigid materials, or a combination of materials of varying rigidity. The secondary chamber 24 need not be rectangular in shape in all embodiments, nor need they be arranged in a rectangular array. In some embodiments the working fluid may be a substance other than air. In another embodiment, the valves 22 can be in a central location and tubing can be run from the flexible manifold 24 to the central location where the valves 22 are located. Further, tube-like structure can be formed within the flexible manifold and run to the central location where the valves are located.

The system for providing fluid to a distributed network of chambers described above is not limited in application to medical therapies. Similar embodiments are envisioned in which manifolds are employed for purposes such as precision positioning of materials.

What is claimed is:

1. A fluid manifold system, comprising:
one or more primary chambers and one or more secondary chambers;
each of the one or more secondary chambers contains a volume of fluid and is connected to a respective underlying primary chamber, which also contains a volume of fluid;
a plurality of valves either distributed throughout the manifold to minimize flow restriction or collected into one or more discrete valve manifolds which are removably fluidly connected to the primary and secondary chambers; and
wherein activating a single valve disconnects one or more of the secondary chambers from the associated primary chamber and connects the same one or more secondary chambers to an alternate primary chamber.

2. The manifold system of claim 1, wherein each of the one or more of the primary and/or secondary chambers are made from a flexible material such as thermoplastic polyurethane, thermoformable plastic, polymer or natural rubber.

3. The manifold system of claim 1, wherein each of the chambers are defined by three sheets of flexible material; each of the three sheets are made of thermoplastic polyurethane, thermoformable plastic, polymer or natural rubber.

4. The manifold system of claim 1, wherein the fluid is air.

5. The manifold system of claim 1, wherein the valves are solenoid valves.

6. The manifold system of claim 1, wherein secondary chambers are arranged in a rectangular array.

7. The manifold system of claim 1, wherein an alternate primary chamber to which each valve can connect one or more of the secondary chambers is the atmospheric environment surrounding the manifold system.

8. The manifold system of claim 1, wherein one or more of the secondary chambers are collected into one or more groups in such a manner that flow between the grouped secondary chambers and a primary chamber is regulated by a single valve for each group.

9. The manifold system of claim 1, wherein the manifold system prevents and/or treats decubitus ulcers in humans.

10. The manifold system of claim 1, wherein the one or more of the primary chambers has one or more orifices through which a volume of fluid can be evacuated rapidly.

11. The manifold system of claim 1, wherein one or more secondary chambers are connected by one or more valves to one of two primary chambers, where one of the primary chambers is encapsulated between layers of flexible material attached to the structure of the secondary chambers and the other primary chamber is the surrounding environment.

12. The manifold system of claim 1, wherein the secondary chambers are connected by valves to one of two or more primary chambers, each of which is encapsulated between layers of flexible material attached to the structure of the secondary chambers, and one of which that may or may not be the surrounding environment.

13. The manifold system of claim 1, wherein multiple instances of the manifold system are provided and connected together by a mechanical or fluid transport structure in such a way that the multiple manifolds function together as a single system.

14. The manifold system of claim 1, further comprising mechanical load sensors configured and arranged for implementing a closed-loop control system.

15. The manifold system of claim 1, wherein fluid pressure sensors are provided and configured and arranged for the implementing a closed-loop control system.

16. The manifold of claim 1, wherein the valves are respectively fluidly connected to corresponding manifolds by flexible tubing.

17. The manifold of claim 1, wherein additional primary chambers and an additional common manifold provide an additional structure to connect patient support chambers to group them in a way that manages pressure redistribution in body regions; the chambers allowing pressure to flow to/from these chamber groupings.

18. The manifold of claim 1, further comprising an exhaust area to a common chamber so fluid can be reused in another region that requires air or has a lower pressure.
